(19) United States
(12) Patent Application Publication
(10) Pub. No.: US 2009/0174699 A1
(43) Pub. Date: Jul. 9, 2009

(54) ELECTROLUMINESCENT DISPLAY DEVICES AN ACTIVE MATRIX

(75) Inventors: David A. Fish, Haywards Heath (GB); Mark J. Childs, Wootton Bassett (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,867

(22) PCT Filed: Jan. 4, 2005
(86) PCT No.: PCT/IB05/50027

§ 371 Date: Jun. 28, 2006

(30) Foreign Application Priority Data
Jan. 7, 2004 (GB) 0400213.5

(51) Int. Cl. G09G 5/00; G09G 3/32

(52) U.S. Cl. 345/214; 345/82

(57) ABSTRACT

An active matrix EL display has first and second capacitors connected in series between the gate and source or drain of a pixel drive transistor. A data input to the pixel is provided to the junction between the first and second capacitors thereby to charge the second capacitor to a voltage derived from the pixel data voltage, and a voltage derived from the drive transistor threshold voltage being stored on the first capacitor. A discharge transistor is connected between the junction between the first and second capacitors and a common line for all pixels of the display. This device uses a common line as a discharge sink/source for the threshold voltage measurement operation. By avoiding the use of a data line for this purpose, the pixel can be in a non-addressed state when the threshold measurement takes place.

This invention relates to electroluminescent display devices, particularly active matrix display devices having thin film switching transistors associated with each pixel.

Matrix display devices employing electroluminescent, light-emitting, display elements are well known. The display elements may comprise organic thin film electroluminescent elements, for example using polymer materials, or else light emitting diodes (LEDs) using traditional III-V semiconductor compounds. Recent developments In organic electroluminescent materials, particularly polymer materials, have demonstrated their ability to be used practically for video display devices. These materials typically comprise one or more layers of a semiconducting conjugated polymer sandwiched between a pair of electrodes, one of which is transparent and the other of which is of a material suitable for injecting holes or electrons into the polymer layer.

The polymer material can be fabricated using a CVD process, or simply by a spin coating technique using a solution of a soluble conjugated polymer. Ink-jet printing may also be used. Organic electroluminescent materials exhibit diode-like I-V properties, so that they are capable of providing both a display function and a switching function, and can therefore be used in passive type displays. Alliteratively, these materials may be used for active matrix display devices, with each pixel comprising a display element and a switching device for controlling the current through the display element.

Display devices of this type have current-driven display elements, so that a conventional, analogue drive scheme involves supplying a controllable current to the display element. It is known to provide a current source transistor as part of the pixel configuration, with the gate voltage supplied to the current source transistor determining the current through the display element. A storage capacitor holds the gate voltage after the addressing phase.

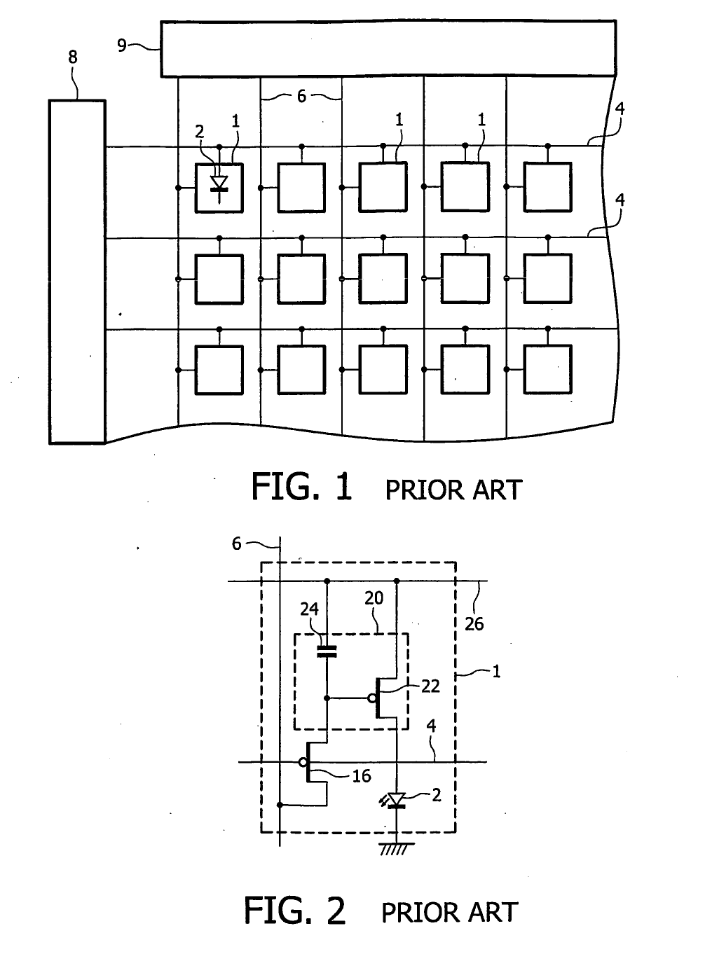

FIG. 1 shows a known pixel circuit for an active matrix addressed electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. Only a few pixels are shown in the Figure for simplicity. In practice there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. The support is of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support. Typically, the thickness of the organic electroluminescent material layer is between 100 nm and 200 nm. Typical examples of suitable organic electroluminescent materials which can be used for the elements 2 are known and described in EP-A-0 717446. Conjugated polymer materials as described in WO96/36959 can also be used.

FIG. 2 shows in simplified schematic form a known pixel and drive circuitry arrangement for providing voltage-programmed operation. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended. The drive transistor 22 draws a current from the power supply line 26.

The drive transistor 22 in this circuit is implemented as a p-type TFT, for example a low temperature polysilicon TFT, so that the storage capacitor 24 holds the gate-source voltage fixed. This results in a fixed source-drain current through the transistor, which therefore provides the desired current source operation of the pixel.

One problem with voltage-programmed pixels, particularly using polysilicon thin film transistors, is that different transistor characteristics across the substrate (particularly the threshold voltage) give rise to different relationships between the gate voltage and the source-drain current, and artefacts in the displayed image result.

Various techniques have been proposed for compensating for these threshold voltage variations. Some techniques perform in-pixel measurement of the drive transistor threshold voltage, and add this threshold voltage to the pixel drive signal, so that the combined drive voltage takes account of the threshold voltage. A pixel circuit to perform this can use two storage capacitors, one for the threshold voltage and one for the pixel drive voltage. Additional switching transistors are also required to enable the threshold voltage to be measured, for example by discharging a capacitance across the gate-source junction of the drive transistor until it turns off.

This type of threshold compensation pixel circuit has two phases to the address cycle. In the first phase, the threshold voltage is stored on a threshold capacitor. In the second phase, the pixel data voltage is stored on a data capacitor. One problem with the known arrangement is that the column line is used for the threshold voltage measurement operation, and this column line is coupled to the pixel through the address transistor controlled by the row. This means that the threshold voltage measurement and the supply of pixel data to the pixel must take place within a row address period.

According to the invention, there is provided an active matrix device comprising an array of display pixels, each pixel comprising:

a current driven light emitting display element;

a drive transistor for driving a current through the display element;

first and second capacitors connected in series between the gate and source or drain of the drive transistor, a data input to the pixel being provided to the junction between the first and second capacitors thereby to charge the second capacitor to a voltage derived from the pixel data voltage, and a voltage derived from the drive transistor threshold voltage being stored on the first capacitor; and

a discharge transistor connected between the junction between the first and second capacitors and a common line for all pixels of the display.

This device uses a common line as a discharge sink/source for the threshold voltage measurement operation. By avoiding the use of a data line for this purpose, the pixel can be in a non-addressed state when the threshold measurement takes place.

Each pixel may further comprise an input transistor connected between an input data line and the junction between the first and second capacitors.

Each pixel is then preferably operable in two modes, a first mode in which the input transistor is off and the voltage derived from the drive transistor threshold voltage is stored on the first capacitor, and a second mode in which the input transistor is on and a data input to the pixel charges the second capacitor to the voltage derived from the pixel data voltage.

This input transistor is the address transistor for the circuit, and is off during the threshold measurement stage.

The drive transistor may be a p-type transistor and the source of the drive transistor is then connected to a power supply line. The common line may then be this power supply line, or it may be a separate line.

Each pixel may further comprise a second transistor connected between the gate and drain of the drive transistor. This is used to control the supply of current from the drain. Thus, by turning on the second transistor, the first capacitor can be charged to the gate-source voltage. The second transistor may be controlled by a first gate control line which is shared between a row of pixels.

In one example, the first and second capacitors are connected in series between the gate and source of the drive transistor.

Each pixel may further comprise a third transistor connected between the drive transistor and the display element. This can be used to isolate the display element during the pixel programming stage.

The display element may comprise an electroluminescent display element

The invention also provides a method of driving an active matrix display device comprising an array of current driven light emitting display pixels, each pixel comprising an display element and a drive transistor for driving a current through the display element, the method comprising, for each pixel:

isolating a data line from the pixel, and while the data line is isolated:
driving a current through the drive transistor, and charging a first capacitor to a resulting gate-source voltage;
discharging the first capacitor through a discharge transistor connected between one terminal of the first capacitor and a common line, until the drive transistor turns off, the first capacitor thereby storing a threshold voltage;

coupling a data line to the pixel, and while the data line is coupled:
charging a second capacitor, in series with the first capacitor between the gate and source or drain of the drive transistor, to a data input voltage from the data line; and

using the drive transistor to drive a current through the display element using a gate voltage that is derived from the voltages across the first and second capacitors.

This method uses a common line as a discharge sink/source for the threshold voltage measurement operation. As mentioned above, avoiding the use of a data line for this purpose enables the pixel to be in a non-addressed state when the threshold measurement takes place.

The isolating and coupling preferably comprises switching an address transistor connected between the data line and an input to the pixel, and this address transistor for each pixel in a row is switched on simultaneously by a common row address control line.

When the data line is isolated from the pixel and the first capacitor is being charged, the data line is preferably used to provide a data input voltage to another pixel associated with the data line. This provides a pipelined is addressing sequence.

The invention will now be described by way of example with reference to the accompanying drawings, in which:

FIG. 1 shows a known EL display device;

FIG. 2 is a schematic diagram of a known pixel circuit for current-addressing the EL display pixel using an input drive voltage;

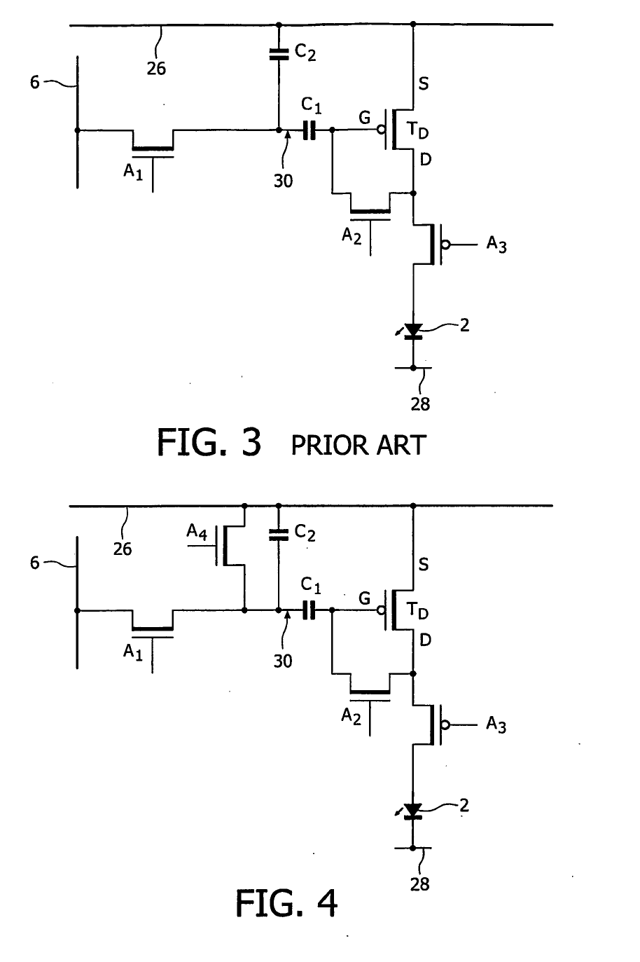

FIG. 3 shows a schematic diagram of a known threshold compensation circuit;

FIG. 4 shows a schematic diagram of an example of pixel layout for a display device of the invention;

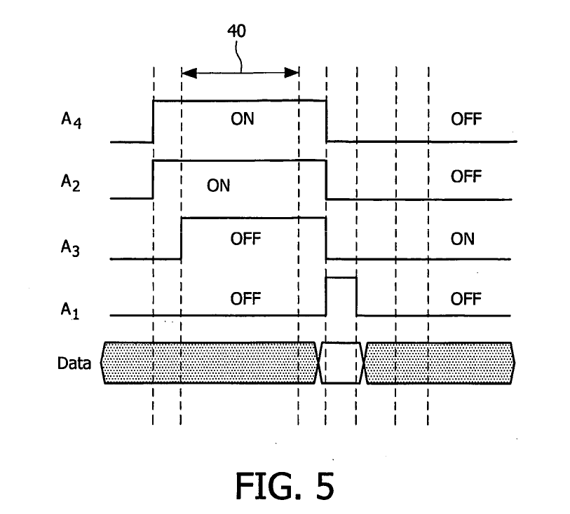

FIG. 5 is a timing diagram for operation of the pixel layout of FIG. 5; and

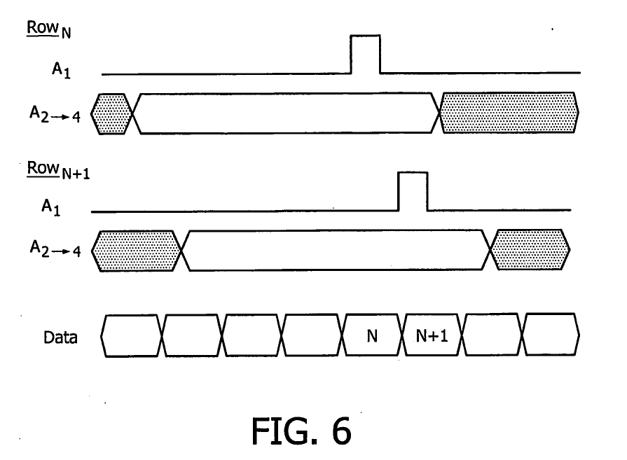

FIG. 6 is used to show how the circuit of the invention enables pipelining to be carried out.

The same reference numerals are used in different figures for the same components, and description of these components will not be repeated.

FIG. 3 shows a known threshold compensation pixel arrangement. Each pixel again has an electroluminescent (EL) display element 2 and a drive transistor T_{D} in series between a power supply line 26 and a grounded common cathode 28. The drive transistor T_{D} is for driving a current through the display element 2.

First and second capacitors C₁ and C₂ are connected in series between the gate and source of the drive transistor T_{D}. A data input to the pixel is provided to the junction 30 between the first and second capacitors and charges the second capacitor C₂ to a pixel data voltage as will be explained below. The first capacitor C₁ is for storing the drive transistor threshold voltage.

An address transistor A₁ is connected between an input data line 6 and the junction 30 between the first and second capacitors. This address transistor times the application of a data voltage to the pixel, for storage on the second capacitor C₂.

A second, shorting, transistor A₂ is connected between the gate and drain of the drive transistor T_{D}. This is used to control a flow of current between the power supply line 26 and the first capacitor C₁ when the drive transistor T_{D} is on.

A third, isolating, transistor A₃ is connected between the drive transistor T_{D} and the anode of the display element 2. This is used to turn off the display element 2 during the threshold measurement operation of the pixel programming sequence.

The transistors A₁ to A₃ are controlled by respective row conductors which connect to their gates.

The addressing of an array of pixels involves addressing rows of pixels in turn, with a full row of pixels addressed simultaneously, in conventional manner. The data line 6 comprises a column conductor, The circuit of FIG. 3 can be operated in a number of different ways. One basic operation will be described, and the problems associated with the circuit will be explained.

Only the drive transistor T_{D} is used in constant current mode. All other TFTs A₁ to A₃ in the circuit are used as switches that operate on a short duty cycle.

The circuit operation is to store the threshold voltage of the drive transistor T_{D} on C₁, and then store the data voltage on C₂ so that the gate-source voltage of T_{D} is the data voltage plus the threshold voltage.

During the threshold voltage measurement, the address transistor A₁ is turned on as is the shorting transistor A₂. The isolation transistor A₃ is initially on, so that current is driven through the display element for a short time, in order to establish a large gate-source voltage on the drive transistor which turns the drive transistor on.

The isolating transistor A₃ is then turned off, and the current sourced by the drive transistor passes from the source to the drain, through the transistor A₂, the capacitor C₁ and the address transistor A₁ to the data line 6. A suitable voltage is provided on the data line 6 for this operation,, for example the same voltage as the power supply line voltage, and this all takes place within the row address period (namely while the address transistor A₁ is turned on).

The flow of charge changes the voltage stored across the capacitor C₁ until the gate-source voltage approaches the threshold voltage. At this time, the drive transistor turns off. With the capacitor C₂ shorted out (because the power supply line voltage is on the data line 6), the capacitor C₁ then stores and holds the threshold voltage.

Subsequently, the shorting transistor A₂ is turned off, and the pixel data is stored on the capacitor C₂ through the address transistor A₁. The transistor A₃ is turned on for the illumination period.

Variations to this circuit are of course possible, for example to avoid the need for a pulse of light to be output during the threshold measurement operation. However, a problem remains that a significant part of the address cycle is taken up by the threshold measurement.

The invention provides a pipelined addressing sequence, so that there can be some timing overlap between the control signals of adjacent rows.

FIG. 4 shows an example of pixel circuit of the invention. The circuit is identical to that shown in FIG. 3. but additionally has a discharge transistor A₄ connected between the junction 30 and the power supply line 26. The function of this transistor is to allow the address transistor A₁ to be turned off during the threshold voltage measurement cycle, so as to free up the column conductor for use in providing pixel data to the pixels in another row.

The operation of the circuit is explained with reference to FIG. 5.

At the beginning of the graphs shown in FIG. 5, the display is emitting light from the previous address period. At the beginning of the programming phase, the shorting and discharge transistors A₂, A₄ are turned on. The junction 30 is then lifted to the power rail voltage, and the gate and drain of the drive transistor T_{D} are connected together. A short pulse of light is emitted while the gate voltage of the drive transistor is stabilised, and then the isolating transistor A₃ is turned off (plot A₃ in FIG. 5 goes high). This directs the drive transistor source-drain current to its own gate. In the same way as for the circuit described above, the gate charges up until the drive transistor gate reaches its threshold voltage, and this is stored on the capacitor C₁.

This charging of the gate has a relatively long time constant. The invention allows this to be carried out with the address transistor turned off (during period 40), so that the time can be “pipelined” with the programming of other rows of pixels with pixel data.

The shorting and discharge transistors A₂, A₄ are then turned off, so that the gate of the drive transistor can float, with the threshold voltage of the drive transistor stored across the capacitor C₁. The isolation transistor A₃ can also be turned on at that time, and no current will flow to the display element until the pixel is addressed with the data voltage.

A short address pulse for the address transistor A₁ is needed at a subsequent time, synchronised with the data on the column (the non-hatched part of the data plot in FIG. 5). The column is at a lower voltage than the power line voltage, which pulls down the drive transistor gate voltage, storing the pixel data voltage on C₂. The combined voltage across the source-gate junction is thus the measured threshold voltage added to the pixel drive voltage.

It can be seen that the plots for transistors A₂ and A₄ are the same, so that they can be controlled by a shared control line.

This pipelining of the addressing sequence allows more than one row of pixels can be programmed at any one time. Thus, the addressing signals on lines A₂ to A₄ can overlap with the same signals for different rows. The length of the addressing sequence does not then imply long pixel programming times, and the effective line time is only limited by the time required to charge the second capacitor C₂ when the address line A₁ is high. This time period is the same as for a standard active matrix addressing sequence. The other parts of the addressing mean that the overall frame time will only be lengthened slightly by the set-up required for the first few rows of the display. However this set up. can easily be done within the frame-blanking period so the time required for the threshold voltage measurement is not a problem.

Pipelined addressing is shown more clearly in the timing diagrams of FIG. 6. The control signals for the transistors A₂ to A₄ have been combined into a single plot, but the operation is as described with reference to FIGS. 4 and 5. The “Data” plot in FIG. 6 shows that the data line 6 is used almost continuously to provide data to successive rows.

In the method of FIGS. 4 and 5, the threshold measurement operation is combined with the display operation, so that the threshold measurement and display is performed for each row of pixels in turn.

It is possible instead to perform all of the threshold measurements for the full display, and then to address.

There are many variations to the specific circuit layout described above which can work in the same way. Differences may be desired to prevent the flash of light during pixel programming. For example, an additional transistor may be provided which gives the drain of the drive transistor a path to ground so that this path can be used to ensure current flow immediately before threshold measurement, instead of using current flow through the display element.

The circuits can be used for currently available LED devices. However, the electroluminescent (EL) display element may comprise an electrophosphorescent organic electroluminescent display element.

The circuit above has been shown implemented with a p-type drive transistor. The invention enables larger area polysilicon arrays to be fabricated because the pixel circuits compensate for the pixel to pixel variations without requiring longer pixel addressing times. These pixel addressing times become a limiting factor when designing large displays. The invention is particularly suitable for displays in which the drive transistor comprises a LTPS transistor.

The invention can be applied to other transistor technologies, such as microcrystalline silicon.

Various other modifications will be apparent to those skilled in the art.

1. An active matrix device comprising an array of display pixels (1), each pixel comprising:
a current driven light emitting display element (2);
a drive transistor (T_{D}) for driving a current through the display element;
first and second capacitors (C₁, C₂) connected in series between the gate (G) and source (S) or drain (D) of the drive transistor (T_{D}), a data input to the pixel being provided to the junction (30) between the first and second capacitors thereby to charge the second capacitor (C₂) to a voltage derived from the pixel data voltage, and a voltage derived from the drive transistor threshold voltage being stored on the first capacitor (C₁); and
a discharge transistor (A₄) connected between the junction (30) between the first and second capacitors and a common line (26) for all pixels of the display.

2. A device as claimed in claim 1, wherein the drive transistor (T_{D}) comprises a p-type thin film transistor.

3. A device as claimed in claim 1, wherein the drive transistor (T_{D}) comprises a polysilicon or microcrystalline silicon transistor.

4. A device as claimed in claim 3, wherein the drive transistor (T_{D}) comprises a low temperature polysilicon transistor.

5. A device as claimed in claim 1, wherein each pixel further comprises an input transistor (A₁) connected between an input data line (6) and the junction (30) between the first and second capacitors.

6. A device as claimed in claim 1, wherein each pixel is operable in two modes, a first mode in which the input transistor (A₁) is off and the voltage derived from the drive transistor threshold voltage is stored on the first capacitor (C₁), and a second mode in which the input transistor (A₁) is on and a data input to the pixel charges the second capacitor (C₂) to the voltage derived from the pixel data voltage.

7. A device as claimed in claim 1, wherein the drive transistor (T_{D}) is a p-type transistor and the source of the drive transistor is connected to a power supply line (26).

8. A device as claimed in claim 7, wherein the common line comprises the power supply line (26).

9. A device as claimed in claim 1, wherein each pixel further comprises a second transistor (A₂) connected between the gate (G) and drain (D) of the drive transistor (T_{D}).

10. A device as claimed in claim 9, wherein the second transistor (A₂) is controlled by a first gate control line which is shared between a row of pixels.

11. A device as claimed in claim 1, wherein the first and second capacitors (C₁,C₂) are connected in series between the gate (G) and source (S) of the drive transistor (T_{D}).

12. A device as claimed in claim 1, wherein each pixel further comprises a third transistor (A₃) connected between the drive transistor and the display element (2).

13. A device as claimed in claim 1, wherein the display element (2) comprises an electroluminescent display element.

14. A device as claimed in claim 13, wherein the electroluminescent (EL) display element (2) comprises an electrophosphorescent organic electroluminescent display element.

15. A method of driving an active matrix display device comprising an array of current driven light emitting display pixels (1), each pixel comprising an display element (2) and a drive transistor (T_{D}) for driving a current through the display element, the method comprising, for each pixel:
isolating a data line (6) from the pixel, and while the data line is isolated:
driving a current through the drive transistor, and charging a first capacitor (C₁) to a resulting gate-source voltage;
discharging the first capacitor (C₁) through a discharge transistor (A₄) connected between one terminal of the first capacitor and a common line, until the drive transistor turns off, the first capacitor (C₁) thereby storing a threshold voltage;
coupling a data line (6) to the pixel, and while the data line is coupled:
charging a second capacitor (C₂), in series with the first capacitor between the gate and source or drain of the drive transistor (T_{D}), to a data input voltage from the data line (6); and
using the drive transistor (T_{D}) to drive a current through the display element using a gate voltage that is derived from the voltages across the first and second capacitors (C₁,C₂).

16. A method as claimed in claim 15, wherein the isolating and coupling comprises switching an address transistor (A₁) connected between the data line (6) and an input (30) to the pixel.

17. A method as claimed in claim 16, wherein the address transistor (A₁) for each pixel in a row is switched on simultaneously by a common row address control line.

18. A method as claimed in claim 17, wherein the address transistors for one row of pixels are turned on substantially immediately after the address transistors for an adjacent row are turned off.

19. A method as claimed in claim 15, wherein when the data line (6) is isolated from the pixel and the first capacitor is being charged, the data line is used to provide a data input voltage to another pixel associated with the data line.

20. A method as claimed in claim 15, for driving a display device in which each pixel comprises a p-type drive transistor.

21. A method as claimed in claim 15, for driving a display device in which the drive transistor comprises a polysilicon or microcrystalline silicon transistor.

22. A method as claimed in claim 21, for driving a display device in which the drive transistor of each pixel comprises a LTPS transistor.
